(19) United States
(12) Patent Application Publication
(10) Pub. No.: US 2006/0180636 A1
(43) Pub. Date: Aug. 17, 2006

(54) Two-piece tube

(76) Inventors: Martin Muehleck, Ebenhausen (DE); Stefan Dorn, Arnstein (DE)

Correspondence Address: STRIKER STRIKER & STENBY, 103 EAST NECK ROAD, HUNTINGTON, NY, 11743, US

(21) Appl. No.: 11/353,812

(22) Filed: Feb. 14, 2006

(30) Foreign Application Priority Data
Feb. 16, 2005 (DE) 10 2005 007 011.6

(51) Int. Cl. B23K 20/00

(52) U.S. Cl. 228/3.1

(57) ABSTRACT

A tube for receiving roller bodies has two tube halves that are joined together in form-locking fashion so as to provide a form lock, and the form lock is configured so that it is undoable only whenever there are no roller bodies located in the tube.

### BACKGROUND OF THE INVENTION

The invention relates to a tube for receiving roller bodies, comprising two tube halves, which are joined together in form-locking fashion.

Such tubes are used for instance in linear roller bearings and ball-and-screw spindle drives for restoring the roller bodies, as is known from German Patent Disclosure DE 102 27 689 A1. In this reference, a tube 11 is shown, comprising two identical tube halves 15. For form-locking connection of the tube halves, protrusions 16 and complementary recesses 17 are provided. Snap connections are also provided, comprising projections 19 and grooves 20. The protrusions and recesses serve primarily to align the two tube halves relative to one another, while the snap connections prevent the tube from falling apart.

Snap connections have the disadvantage that they must be manufactured relatively precisely, if a play-free connection of the two tube halves is to be assured. This problem is exacerbated by the fact that such tubes typically have a diameter of only about 10 mm and are injection-molded from plastic; that is, on the one hand the projection is relatively small and on the other it is produced by a method that is of only limited precision. Moreover, snap connections have the disadvantage that tube halves which can be produced only with a complicated injection mold are present on the tube halves. Another disadvantage is the deformation of the projections that occurs upon assembly of the tube. Brittle materials can therefore not be employed for the tube. Moreover, the tube cannot readily be dismantled.

### SUMMARY OF THE INVENTION

It is therefore the object of the invention to create a tube for receiving roller bodies, comprising two tube halves which are joined together in form-locking fashion, which makes do without a snap connection. This object is attained in that the form lock is undoable only whenever there are no roller bodies located in the tube. In use of the tube, however, there are always roller bodies located in it, and it is therefore possible to dispense entirely with a snap connection for holding together the form-locking connection of the two tube halves.

This kind of form-locking connection can be implemented in a simple way by providing that each tube half has at least two flange portions with contact faces, and the preferably identical tube halves rest displaceably on another on the contact faces, and a displacement of the two tube halves relative to one another is possible only whenever no roller bodies are located in the tube.

In the case of a straight tube, flat contact faces may be provided, which are located in the same plane that also contains the center line of the tube. Thus the two tube halves can be displaced relative to one another, specifically along the center line and transversely to it. A transverse displacement, however, is made impossible by the roller bodies in the tube. In the case of a tube that is bent in only one plane, as is the case for instance in the return tube of a ball-and-screw spindle drive, contact faces may be provided that are curved in only one direction, so that a displacement transversely to the direction of curvature is also possible.

In a refinement of the invention, it is provided that at least one flange portion of the one tube half has at least one recess, and a complementary flange portion of the other tube half has an engagement portion, which engages the recess in form-locking fashion, and the form-locking engagement is undoable by displacement of the two tube halves relative to one another. It is thus assured that the two tube halves are kept together in one relative position, while in another relative position they can be separated from one another. In straight,tubes with flat contact faces, a displacement of the two tube halves relative to one another in the direction of the center line of the tube is also prevented. The recess is preferably embodied as open toward the edge of the flange portion, to avoid undercuts that are difficult to produce and to save space. The engagement portions may for instance be embodied as T-shaped extensions.

It can also be provided that on the contact faces of the at least two flange portions, locking means are provided, which prevent the displacement of the two tube halves relative to one another. As a result, building the tube into a linear roller bearing or a ball-and-screw spindle drive is made simpler, because the tube can no longer fall apart so easily. It should be noted in this respect that the roller bodies are typically inserted only after the tube has been built in. The locking means may for instance be embodied as spherical extensions and as complementary bores. The dimensions of the locking means are defined in accordance with the desired retention force and the allowed material deformation.

Preferably, on the inside circumference of the tube, clearances are provided, which define-runup faces for the roller bodies, and the clearances are located in the region of the contact face of the tube halves. In a tube of the invention, it can happen that a step is created in the region of the contact faces, caused by a minimal displacement of the tube halves relative to one another. These steps would mean that when roller bodies move through the tube, unilateral frictional forces would engage them. Particularly with rollers this would cause skewing of the rollers, thus impairing the concentricity of the higher-order roller rail guide. Because the runup faces are small compared to the inside circumference, there is furthermore overall less frictional resistance as the roller bodies pass through the tube.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective view of a tube of the invention in the assembled state; and

FIG. 2 shows a perspective view of the two tube halves of the tube of FIG. 1.

### DESCRIPTION OF THE PREFERRED EMBODIMENTS

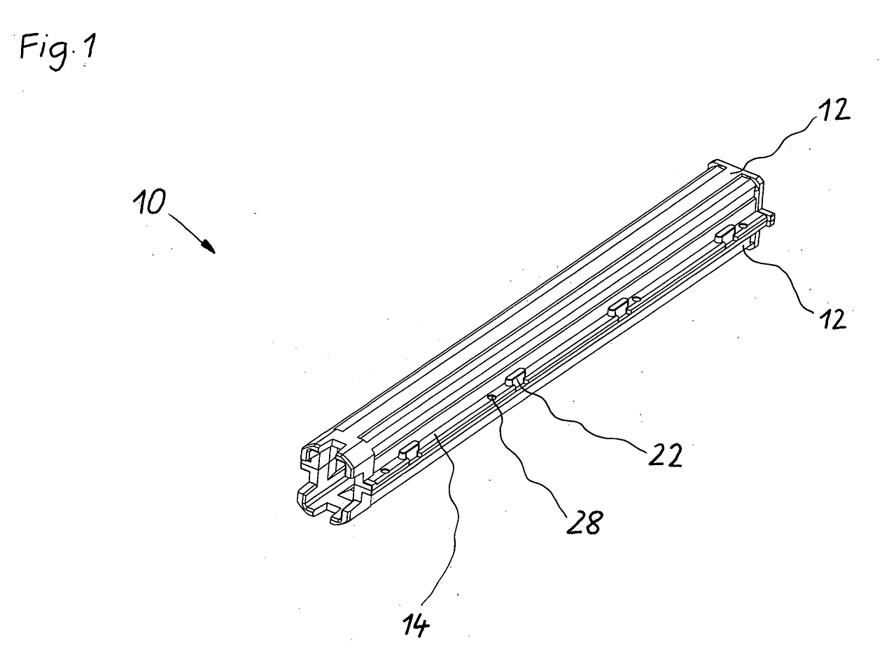

In FIG. 1, a tube of the invention is identified very generally by reference numeral 10. It comprises two identical tube halves 12, which are joined together, rotated 180° relative to one another. This tube is intended to receive roller-like roller bodies, not shown, and it therefore has a rectangular internal contour. The tube is used as a return tube in a linear roller bearing, namely a roller rail guide. The two tube halves 12 are made from plastic by injection molding.

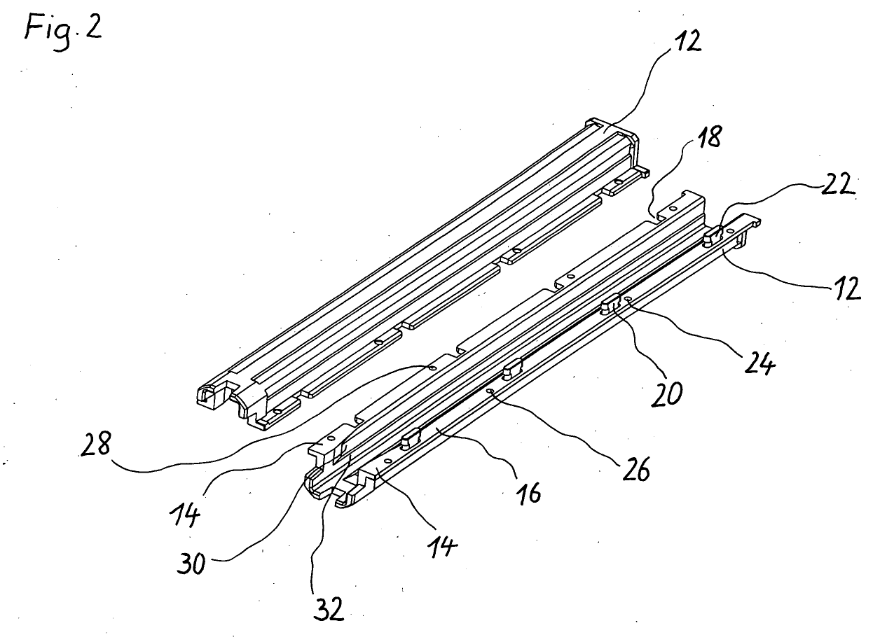

In FIG. 2, the two tube halves 12 are shown in more detail. The tube halves 12 have two flange portions 14, on which flat contact faces 16 are provided. The flat contact faces 16 are located in the same plane that contains the straight center line of the tube.

A plurality of recesses 18, open toward the side, are provided on one flange portion 14. On the other, complementary flange portion 14, engagement portions 20 are provided. They are formed as T-shaped extensions 22, which are capable of engaging the recesses 18, as can be seen from FIG. 1.

Locking means 24 in the form of spherical extensions 26 and complementary bores 28 are also provided on the flange portions 14. The height of the spherical extensions 26 amounts to approximately 20% of the bore diameter.

On the inside circumference of the tube 10, clearances 30 are provided, which define runup faces 32 for the rollers, so that the rollers touch the inside circumference of the tube only at the runup faces 32. The clearances 30 are provided on all four internal sides of the tube 10.

It will be understood that each of the elements described above, or two or more together, may also find a useful application in other types of constructions differing from the types described above.

While the invention has been illustrated and described as embodied in a two-piece tube, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A tube for receiving roller bodies, comprising two tube halves that are joined together in form-locking fashion so as to provide a form lock, said form lock being configured so that it is undoable only whenever there are no roller bodies located in the tube.

2. A tube as defined in claim 1, wherein each of said tube halves has at least two flange portions with contact faces, said tube halves resting displaceably on another of said contact faces, and a displacement of said two tube halves relative to one another is possible only whenever no roller bodies are located in the tube.

3. A tube as defined in claim 2, wherein said tube halves are configured as identical tube halves.

4. A tube as defined in claim 2, wherein at least one flange portion of one of said tube halves has at least one recess, while a complimentary flange portion of the other of said tube halves has an engagement portion, which engages said at least one recess in form-locking fashion to provide a form-locking engagement, said form-locking engagement being configured so that it is undoable by displacement of said two tube halves relative to one another.

5. A tube as defined in claim 2, wherein on said contact faces of at least one of said flange portions, locking means are provided, which are configured so as to prevent a displacement of said two tube halves relative to one another.

6. A tube as defined in claim 2, wherein on an inside circumference of the tube, clearances are provided which define runup faces for the roller bodies, said clearances being located in a region of said contact faces of said tube halves.
